(19) United States
(12) Patent Application Publication
(10) Pub. No.: US 2009/0296272 A1
(43) Pub. Date: Dec. 3, 2009

(54) VIBRATION ISOLATION ASSEMBLY

(76) Inventor: Mark Raymond Doehmann, Victoria (AU)

Correspondence Address: FROMMER LAWRENCE & HAUG, 745 FIFTH AVENUE- 10TH FL., NEW YORK, NY, 10151, US

(21) Appl. No.: 12/159,873

(22) PCT Filed: Dec. 12, 2006
(86) PCT No.: PCT/AU06/01880

§ 371 Date: Dec. 11, 2008

(30) Foreign Application Priority Data
Jan. 3, 2006 (AU) 2006900014
Oct. 19, 2006 (AU) 2006905839

(51) Int. Cl. G11B 33/14

(52) U.S. Cl. 360/97.02; G9B/33.035

(57) ABSTRACT

An assembly for isolating a component from vibrations present in a chassis. The assembly includes a support platform configured to carry the component. A first magnet is fixed relative to the support platform and a second magnet is fixed relative to the chassis, the first and second magnets being positioned and orientated such that a magnetic attractive force occurs there between. A spacing means is arranged to prevent the magnets coming into contact with each other whilst allowing relative movement between the magnets in a direction lateral to the magnetic attractive force. The spacing means may include a plurality of tension strings which pull the magnets apart or compliant material which pushes the magnets apart. The assembly is especially suited for use in a high-fidelity turntable to isolate a tonearm, or a tonearm mounting board, from vibrations present in the chassis of the turntable.

### FIELD OF THE INVENTION

The present invention relates generally to apparatus for isolating equipment from external vibrations. In particular, the invention concerns an assembly for isolating a component from vibrations in a chassis. The assembly is especially suited for use in a high-fidelity turntable and it will therefore be convenient to describe the invention in relation to that example application. It should be understood however that the invention is intended for more general application and use.

### BACKGROUND OF THE INVENTION

High-fidelity audio equipment, such as a turntable, is particularly susceptible to external sources of vibration which can effect the sonic performance of the equipment. Ideally, the turntable should be completely isolated from vibrations present in the surrounding environment, such as the listening room. Suitable equipment racks or support tables have been developed for this purpose and these have, to some degree at least, been successful in isolating the turntable, as a whole, from vibrations present in the listening room.

In a conventional vinyl record, the shape of the mechanical groove pressed into the vinyl represents a mechanical analog of the original acoustic signal recorded. A pickup cartridge is used to track the mechanical groove and thereby generate an electrical signal representing the shape or “wiggle” of the groove as the platter of the turntable is rotated by a motor.

Conventional wisdom suggests that if the motor spins at the correct speed reasonably constantly, measurable wow (slow variations below the audio bandwidth) and flutter (rapid variations near or within the audio bandwidth) would be minimal and any residual effects could be smoothed with a heavy platter acting as a flywheel. If the motor vibrates, and they tend to do so because no motor is perfect, this will raise the playback noise floor, due to what is commonly referred to as “motor rumble”. Various systems of belts and springs have been employed to minimize these effects.

In a conventional turntable, the pickup cartridge is mounted on a tonearm which, in turn, is mounted on the chassis of the turntable. The drive motor and the platter bearing are also mounted on the chassis and the motor is connected, either by a pulley or direct drive, to the platter. Any vibrations produced by “cogging” (ie. stepped motion) of the motor, or due to any imperfections in the platter bearing, are carried through into the chassis of the turntable. In turn, vibrations in the chassis are also transmitted to the tonearm and then to the pickup cartridge to be converted into an electrical signal which is superimposed upon the desired electrical signal, produced by the pickup cartridge, representing the wiggles of the groove of the record.

It would therefore be desirable to provide an apparatus for isolating the tonearm from the chassis.

### SUMMARY OF THE INVENTION

One aspect of the present invention provides an assembly for isolating a component from vibrations present in a chassis. The assembly includes:

a support platform configured to carry the component;

a first magnet fixed relative to the support platform;

a second magnet fixed relative to the chassis, the first and second magnets being positioned and orientated such that a magnetic attractive force occurs there between; and

a spacing means arranged to prevent the magnets coming into contact with each other whilst allowing relative movement between the magnets in a direction lateral to the magnetic attractive force.

In this context the term “chassis” is to be understood to mean any form of structure used to support other components or equipment. Thus, a plinth, base, frame, carcass, body, or housing of any type would be considered to be a chassis.

In a turntable application, the component being isolated could be the tonearm of the turntable or could be a mounting board for the tonearm. Such a mounting board is often referred to as an “arm board”.

In this application, the assembly of the present invention serves to isolate the tonearm from vibrations present in the chassis. These vibrations may originate from the turntable motor or platter bearing or may originate from external sources within the listening environment, for example from the loudspeakers of the audio reproduction system. Typically, sound from the loudspeakers is transmitted through the floor of the listening room (particularly if it is timber) through to the equipment rack or table supporting the turntable and hence to the chassis of the turntable. The assembly of the present invention also serves to provide an additional level of isolation from these externally induced vibrations.

In a preferred embodiment of the assembly, the first and second magnets are substantially vertically aligned such that the first magnet is an upper magnet and the second magnet is a lower magnet. Because the upper and lower magnets are attracted to each other but are prevented from making actual contact by the spacing means, the assembly tends to seek an equilibrium position in which the upper magnet is centered over the lower magnet. This is advantageous when the assembly is used to mount a pivoting tonearm because the pivot point of the tonearm is kept in a fixed position relative to the axis of rotation of the turntable platter. At the same time, however, the tonearm is isolated from vibrations present in the chassis of the turntable.

The spacing means may include any suitable form of assembly, device or material which prevents the magnets making actual contact with each other whilst at the same time allowing relative movement between the magnets in a direction lateral to the magnetic attractive force. For example, the spacing means may include an assembly, located outside of the magnets, which pulls the magnets apart or it may include a material, located between the magnets, which pushes them apart. It may also act directly on each magnet or it may act on intermediate components associated with one or both of the magnets. In either case, the magnets are able to “self centre” to an equilibrium position.

In one embodiment, the assembly also includes a mounting pod positioned between the support platform and the first magnet. The support platform is fixed to an upper surface of the mounting pod and the first magnet is fixed to a lower surface of the mounting pod. Preferably, the second magnet is fixed relative to a lower part of the chassis and the spacing means includes a plurality of tension strings suspending the mounting pod from an upper part of the chassis such that a gap is maintained between the first and second magnets. Each tension string may be provided with an adjustment means to enable adjustment of the gap between the magnets.

Preferably, each tension string includes a plurality of micro-fibres and, more preferably, each string includes a plurality of low stretch, high strength fibres, such as Kevlar™. Advantageously, four tension strings are provided and these may be spaced around a peripheral edge of the mounting pod.

In a preferred arrangement, another pair of magnets is employed. In this arrangement, a third magnet is fixed relative to the support platform and spaced from the first magnet. A fourth magnet is fixed relative to the chassis and spaced from the second magnet such that a magnetic attractive force occurs between the third and fourth magnets. With this arrangement, the position of the mounting pod is held by two pairs of magnets and any twisting or rotation of the mounting pod is substantially prevented. Advantageously, the third magnet is fixed to a lower surface of the mounting pod and the fourth magnet is fixed relative to a lower part of the chassis.

In an alternative embodiment of the assembly, the spacing means may include a compliant material sandwiched between the magnets. The compliant material thereby serves to keep the magnets apart but still allow relative movement between the magnets in a direction lateral to the magnetic attractive force. The magnets are thus able “self centre” to an equilibrium position. Preferably, the compliant material includes a mass loaded elastomer.

This embodiment of the assembly may also include at least one further pair of magnets. More specifically, the assembly may include:

a third magnet fixed relative to the support platform and spaced from the first magnet;

a fourth magnet fixed relative to the chassis and spaced from the second magnet such that a magnetic attractive force occurs between the third and fourth magnets; and

a second spacing means, including a compliant material sandwiched between the third and fourth magnets, to prevent the magnets coming into contact with each other but allow relative movement between the magnets in a direction lateral to the magnetic attractive force.

Once again, with this arrangement, the position of the support platform is held by two pairs of magnets and any twisting or rotation of the support platform is substantially prevented.

In another aspect of the invention there is provided an assembly for isolating a component from vibrations present in a chassis, the assembly including:

a support platform configured to carry the component;

a first magnet fixed relative to the support platform;

a second magnet fixed relative to the chassis, the first and second magnets being positioned and orientated such that a magnetic attractive force occurs there between; and

a spacing means, including a compliant material sandwiched between the magnets, to prevent the magnets coming into contact with each other but allow relative movement between the magnets in a direction lateral to the magnetic attractive force.

In a further aspect of the invention there is provided a turntable including a tonearm mounting board for fixing a tonearm thereto, a chassis, and an assembly as described above for isolating the tonearm mounting board from the chassis. Preferably, a second assembly is provided, spaced from the first assembly, and the tonearm mounting board is secured to both assemblies.

To assist the further understanding of the invention, reference is now made to the accompanying drawings which illustrate preferred embodiments of the invention. It is to be appreciated that these embodiments are given by way of illustration only and the invention is not to be limited by this illustration.

### BRIEF DESCRIPTION OF THE DRAWINGS

In the drawings:

FIG. 1 shows a perspective view of a turntable, with the top cover removed, utilizing an isolation assembly according to a preferred embodiment of the invention;

FIG. 2 shows a top view of the turntable of FIG. 1;

FIG. 3 shows a side cross-sectional view of the turntable of FIG. 1 taken along line 3-3 in FIG. 2;

FIG. 4 shows a partial side perspective view of the isolation assembly used in the turntable of FIG. 1;

FIG. 5 shows a further partial side perspective view of the isolation assembly shown in FIG. 4;

FIG. 6 shows a perspective view of different turntable, with the top cover removed, utilizing an isolation assembly according to another preferred embodiment of the invention;

FIG. 7 shows a top view of the turntable of FIG. 6;

FIG. 8 shows a side cross-sectional view of the turntable of FIG. 6 taken along line 8-8 in FIG. 7;

FIG. 9 shows a side perspective view of a support platform, in the form of a tonearm mounting board, and isolation assemblies used in the turntable of FIG. 6; and

FIG. 10 shows an exploded perspective view of some parts of the isolation assembly shown in FIG. 9.;

### DETAILED DESCRIPTION OF PREFERRED EMBODIMENTS

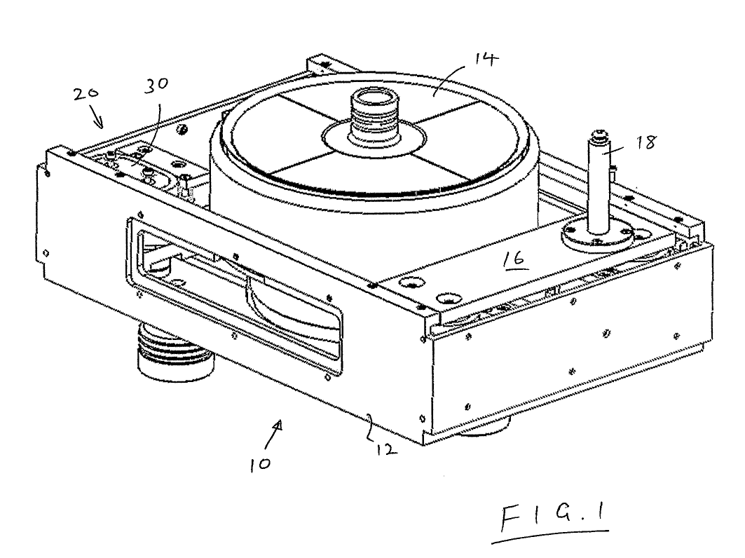

Referring now to FIGS. 1 to 5 of the drawings there is shown a turntable 10 for playing vinyl records (not shown). The turntable 10 has had its top and side covers removed so that the internal components of the turntable can be easily seen. The turntable 10 includes a chassis 12, a platter 14 driven by a motor (not shown), a tonearm mounting board or “arm board” 16, and a tonearm mounting post 18. In use, a tonearm (not shown) is secured to the tonearm mounting post 18. In alternative embodiments, however, any other form of mounting of the tonearm to the arm board 16 may be employed.

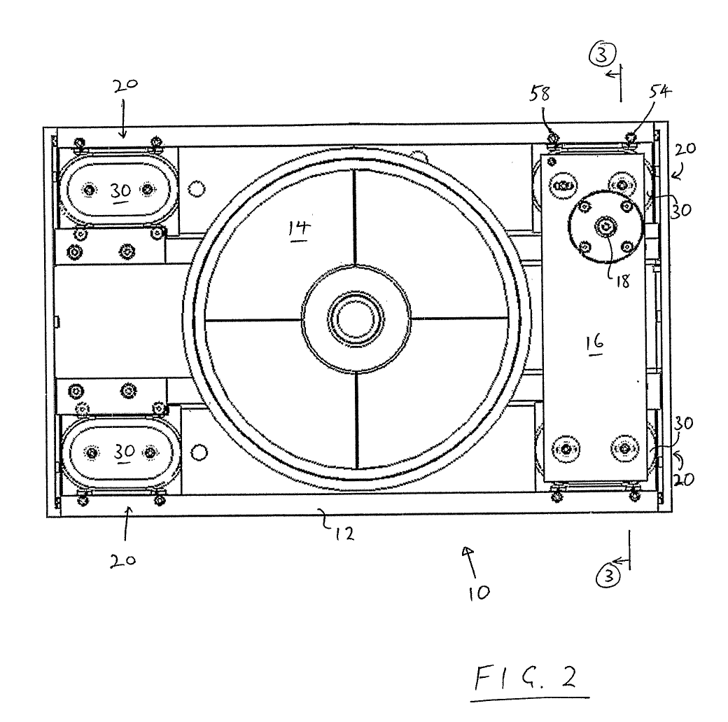

The turntable 10 includes four vibration isolation assemblies, indicated generally by reference numeral 20 in the drawings, one in each corner of the turntable 10. As best seen in FIG. 2, the arm board 16 is secured to the chassis 12 by means of the two right-hand vibration isolation assemblies 20. The two left-hand vibration assemblies may be used to secure a second arm board to the turntable 10 if required.

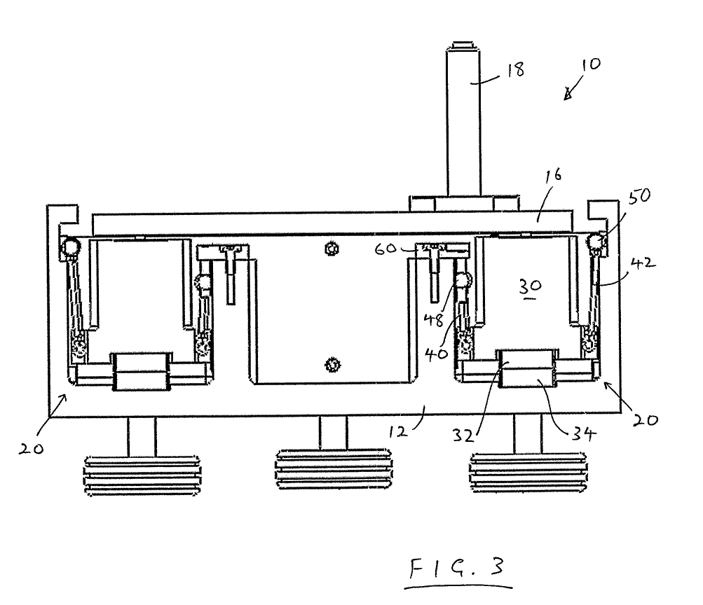

Referring now to FIG. 3 there is shown a partial cross-sectional side view of the turntable 10 taken through the two left-hand vibration isolation assemblies 20 (section 3-3 in FIG. 2). It can be seen that each assembly 20 includes a mounting pod 30 to which the arm board 16 is attached. A first upper magnet 32 is fixed to a lower surface of the mounting pod 30. A second lower magnet 34 is fixed to a lower part of the chassis 12 and the upper and lower magnets 32 and 34 are positioned such that a magnetic attractive force is created therebetween.

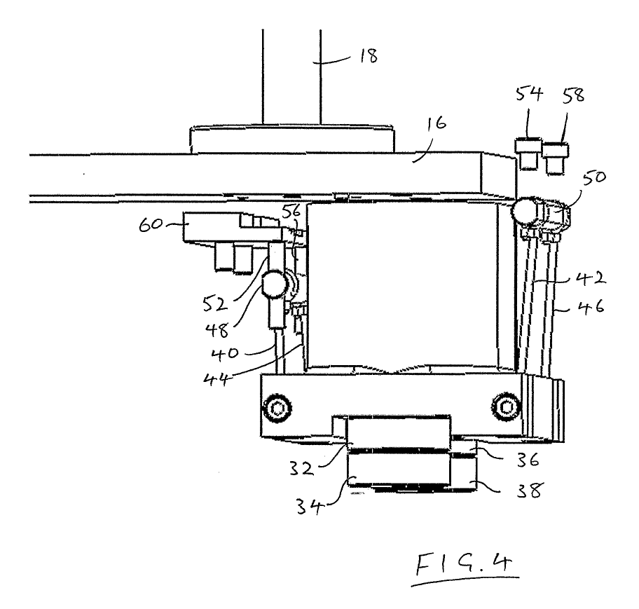

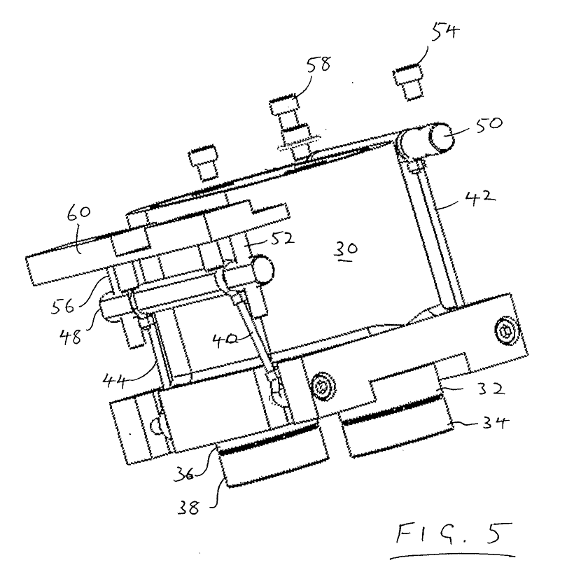

As can be best seen in the detailed perspective views shown in FIGS. 4 and 5, the assembly 20 of this embodiment includes four magnets 32 to 38 with the first upper magnet 32 and the second lower magnet 34 forming a first pair, and a third upper magnet 36 and a fourth lower magnet 38 forming a second pair. The two pairs of magnets increase the downward force on the mounting pod 30.

Four low stretch, high strength tension strings 40 to 46 suspend the mounting pod 30 from an upper part of the chassis 12 (as best seen in FIG. 3) by means of tension rods 48 and 50. These rods are adjustably secured to the chassis 12 by means of screw-threaded fasteners 52 to 58.

The tension strings 40 to 46 serve to maintain a gap between the upper magnets 32 and 36 and the corresponding lower magnets 34 and 38. The minimum possible gap is desired and is preferably less than about 0.5 mm. The exact distance of the gap may be adjusted by tightening or loosening the fasteners 52 to 58.

In the assembly shown in FIGS. 4 and 5, the left-hand tension rod 48 is secured to the chassis 12 by means of a mounting bracket 60 but it will be appreciated that this mounting bracket may not be needed in other embodiments.

In use, any vibration transmitted from the chassis 12 along the tension strings 40 to 46 is damped by the magnets 32 to 38. The smaller the gap between the upper and lower magnets the higher the damping effect.

This approach is based on an observation of a guitar string. However, a guitar string is fixed at both ends and the string constantly stretches and contracts between the “nut” and the “bridge” of the guitar to sustain the vibration. In the vibration isolation assembly of the present invention, however, one end of the string is not fixed but, instead, is movable against the attractive force of the magnets. Since the magnets are always trying to reach an equilibrium position the energy is dissipated from the end of the string.

In addition, each tension string 40 to 46 includes a bunch of very fine micro-fibres which tend to rub against one another when vibrated. In doing so, the friction between the micro-fibres further dissipates energy within the string.

The exact material used for the strings is not important, merely that they exhibit low stretch characteristics and be of sufficient strength. For example, an aramid fibre such as Kevlar™, has been found to be suitable, but hemp, sisal, polyester, rayon, nautical sail yarn, carbon fibre, or any other low stretch cord could be used.

With this embodiment of the vibration isolation assembly installed in a turntable there might be a very small amount of lateral movement of the arm board possible. However, the lateral force required to overcome the force of the magnets is far in excess of the force which the stylus of a pickup cartridge would exert. In a prototype turntable it has been found that a weight in excess of 5 kg needs to be applied to laterally shift the arm board 16.

In the embodiment shown, two pairs of magnets and four tension strings are used for each isolation assembly 20 in order to prevent tipping and rocking of the arm board 16. The aim is to prevent any twist or yaw of the arm board 16 because any movement of the arm board would be transmitted to the tonearm, and hence to the pickup cartridge. The two pairs of magnets also increase the down force so that the tension in the strings is increased.

The shape and size of the mounting pods 30 is determined according to the design of the turntable and their positioning within the chassis 12. In the prototype turntable each of the mounting pods weighs about 5 kg and is made of aluminum filled with lead shot, so that they do not “ring”. However, any other well damped material could be used. For example, cast iron has also been found to be a suitable alternative. The size of the mounting pods is also chosen to provide some separation between the magnets and the tonearm, in order to prevent the magnetic field from the magnets influencing the small voltage signal being produced by the pickup cartridge and carried by wires within the tonearm. Thus, the height of the mounting pods may be selected to provide an appropriate amount of separation.

To further reduce stray magnetic fields, each of the magnets is mounted within an open metal cup which serves to create a substantially closed magnetic circuit when the magnet pairs are in close proximity with a small gap.

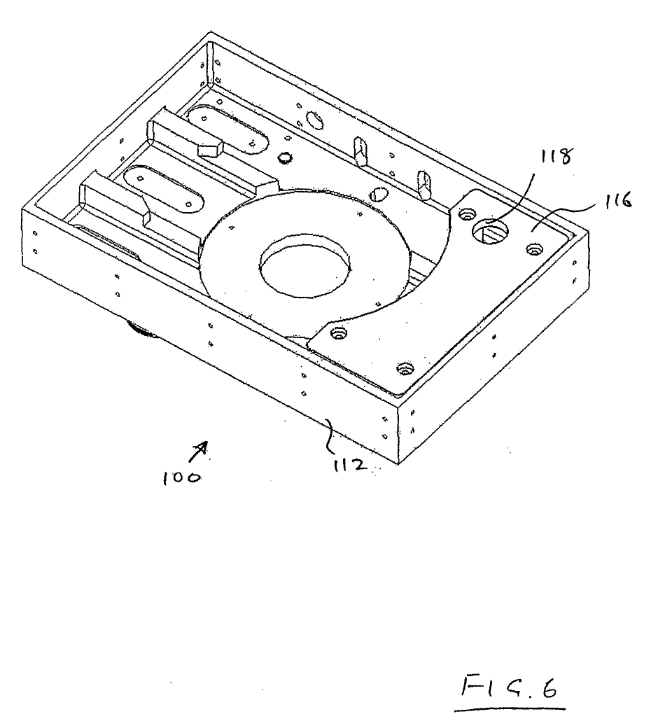

Referring now to FIGS. 6 to 10 of the drawings there is shown another turntable 100 utilizing an isolation assembly in accordance with an alternative preferred embodiment of the invention. The turntable 100 has had its top and side covers removed so that the internal components of the turntable can be easily seen.

The turntable 100 includes a chassis 112, a platter (not shown) and a tonearm mounting board 116. The tonearm mounting board includes an aperture 118 within which a tonearm (not shown) may be secured.

The turntable 100 may include four isolation assemblies, one in each corner of the turntable, for supporting two tonearm mounting boards. In the embodiment shown, however, there is only one tonearm mounting board 116 supported by two isolation assemblies, referred to generally by reference numeral 120 in the drawings.

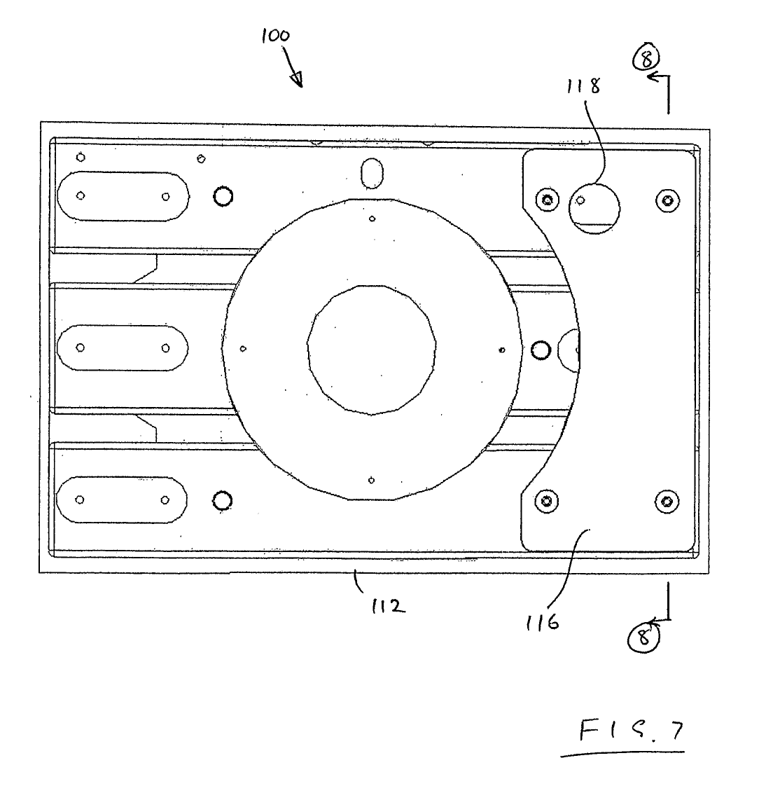

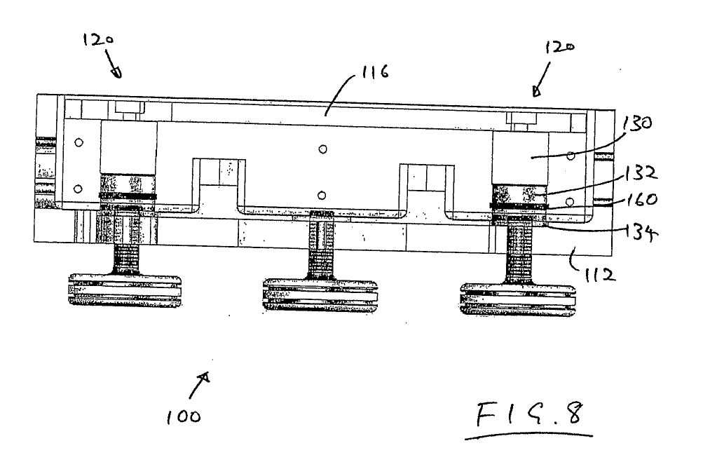

FIG. 7 shows a top view of the turntable 100 shown in FIG. 6 and FIG. 8 shows a partial side cross-sectional view of the turntable taken along the line 8-8 in FIG. 7. In this embodiment, it can be seen that each isolation assembly 120 includes a form of mounting pod 130 to which the arm board 116 is attached. A first upper magnet 132 is fixed to a lower surface of the mounting pod 130, a second lower magnet 134 is fixed to a lower part of the chassis 112 and the upper and lower magnets 132 and 134 are positioned such that a magnetic attractive force is created there between.

In this embodiment, a spacer 160 is sandwiched between the upper and lower magnets 132 and 134. The spacer serves to prevent the magnets coming into contact with each other but still allows some relative movement between the magnets in a direction lateral to the magnetic attractive force. In this way, the magnets are drawn towards each other until they find an equilibrium position. The spacer 160 may be made of any suitable compliant material and, in this regard, a “rubber-like” elastomer, and preferably a mass loaded elastomer, would be used. In this way, the compliance of the material allows the magnets to pull back towards an equilibrium position (not unlike the string arrangement of the embodiment shown in FIGS. 1 to 5 of the drawings) and the mass loading of the elastomer provides additional vibration damping.

Some examples of suitable compliant materials may include a product sold under part No. C1002 by EAR Specialty Composites, a viscoelastic material such as Sorbothane™ available from Sorbothane Inc. or Scotchdamp™ 112 available from the 3M Company.

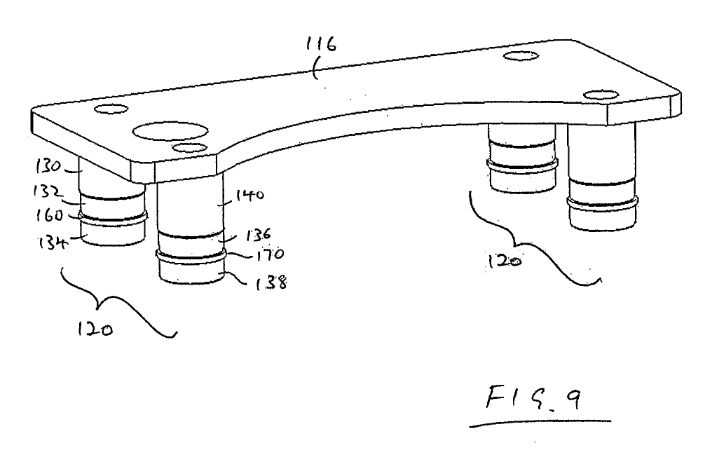

Referring now to FIG. 9, there is shown a perspective view of the arm board 116 and two isolation assemblies 120. In this embodiment, each assembly includes two mounting pods 130, 140 and four magnets 132 to 138 together with two spacers 160 and 170. The first upper magnet 132 and the second lower magnet 134 form a first pair, and a third upper magnet 136 and a fourth lower magnet 138 form a second pair. The two pairs of magnets firmly secure one end of the arm board 116 and prevent it from moving laterally or twisting around its longitudinal direction.

As can also be seen in FIG. 9, the other end of the arm board 116 is secured by a second isolation assembly 120 similarly including two pairs of magnets. In this way, the position and orientation of the arm board 116 is held firm, relative to the chassis 112 by the four pairs of magnets.

It will be appreciated that within each isolation assembly 120, there are two identical subassemblies, each of which could be individually considered to be an isolation assembly. It is simply a matter of convenience, for comparison with the embodiment shown in FIGS. 1 to 5, that two pairs of magnets have been treated as a single isolation assembly 120. For example, it will be appreciated that in an alternative configuration three pairs of magnets, and associated spacers, may be employed to support the arm board 116. The terminology adopted herein is merely a matter of convenience.

It should also be appreciated that the mounting pods 130 and 140 in this embodiment serve as spacers to support the arm board 116 at the required height relative to the chassis 112 of the turntable, and hence the platter. Depending upon the arrangement of the arm board 116 and the chassis 112, the mounting pods 130 and 140 may not be required. Alternatively, the mounting pods may be positioned below the magnet pairs such that the upper magnets 132 and 136 are fixed directly to the arm board 116. In part, the arrangement shown in the drawings has been employed so as to provide some degree of physical separation between the upper magnets 132 and 136 from the arm board 116 and hence from the low level electrical signals which would be carried by conductors within the tonearm (not shown) fixed to the mounting board 116.

As mentioned above, the compliance of the spacers 160 and 170 allows lateral movement of the upper magnets 132 and 136 relative to the lower magnets 134 and 138, and hence the chassis 112. This compliance also means that the attractive force between the magnets will compress the spacers to some degree. The amount of this compression will depend on the particular material selected, and hence will effect the degree of isolation provided for the arm board 116. More particularly, the properties of the material will effect the degree of damping of vibration energy as that energy is dissipated within the material. It is for this reason that a mass loaded elastomer has been found to be particularly suitable because a range of materials with defined characteristics are commercially available.

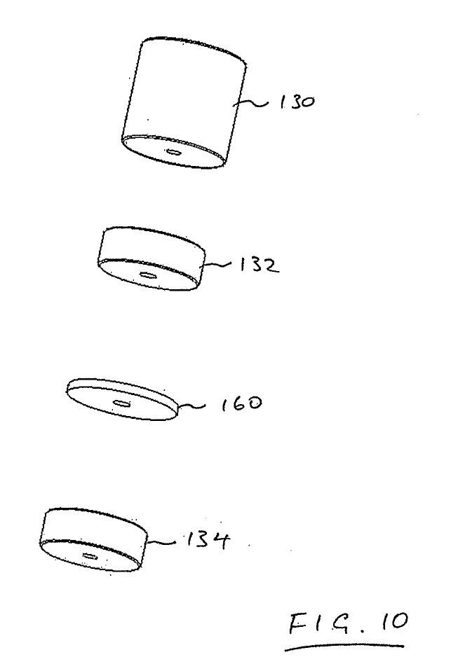

Referring now to FIG. 10 there is shown an exploded perspective view of a subassembly of one of the isolation assemblies 120. As described above, the mounting pod 130 is fixed to the arm board 116 (not shown in FIG. 10). The upper magnet 132 is fixed to a lower surface of the mounting pod 130. The lower magnet 134 is fixed to the chassis 112 (not shown in FIG. 10) and the spacer 160 is sandwiched between the upper and lower magnets 132 and 134. In this arrangement, the mounting pod 130 provides some additional suspended mass, in conjunction with the arm board 116, but this is not essential. Any suitable material, such as aluminum for example, may be used for the mounting pod 130.

The arrangement shown in FIG. 10 could also be reversed, such that the upper magnet is fixed directly to the arm board 116 and the mounting pod is fixed to the chassis 112. Alternatively, the mounting pod 130 may be omitted altogether.

The vibration isolation assembly of the present invention, in both of its presently preferred forms, has been found to be extremely effective for preventing chassis vibrations, whether produced by other components secured to the chassis or by external sources, being transmitted to the arm board of a turntable. The assembly effectively forms a “quiet zone” within the turntable for mounting of the tonearm. A turntable incorporating such an assembly has been found to have significantly improved sonic performance compared to a turntable not having the assembly.

Although preferred embodiments of the invention have been described herein in detail, it will be understood by those skilled in the art that variations may be made thereto without departing from the spirit of the invention or the scope of the appended claims. For example, any number of magnet pairs and any number of tension strings, in the embodiment having a suspended mounting pod, could be used. A single magnet pair and three strings might be a suitable alternative in given situations.

Similarly, it should be understood that the vibration isolation assembly of the present invention may be used for applications other than turntables, for example microscopes, optical measurement apparatus, devices using sonic transducers, or any other device which needs to be isolated from vibrations present within its support structure or the surrounding environment.

1. An assembly for isolating a component from vibrations present in a chassis, the assembly including comprising:
a support platform configured to carry the component;
a first magnet fixed relative to the support platform;
a second magnet fixed relative to the chassis, the first and second magnets being positioned and orientated such that a magnetic attractive force occurs there between; and
a spacing means comprising a plurality of tension strings arranged to suspend the support platform relative to the chassis and prevent the magnets coming into contact with each other whilst allowing relative movement between the magnets in a direction lateral to the magnetic attractive force.

2. The assembly of claim 1 wherein the first and second magnets are substantially vertically aligned such that the first magnet is an upper magnet and the second magnet is a lower magnet.

3. The assembly of claim 1, further including comprising a mounting pod positioned between the support platform and the first magnet, wherein the support platform is fixed to an upper surface of the mounting pod and the first magnet is fixed to a lower surface of the mounting pod.

4. The assembly of claim 3 wherein the second magnet is fixed relative to a lower part of the chassis and the spacing means comprises a plurality of tension strings suspending the mounting pod from an upper part of the chassis such that a gap is maintained between the first and second magnets.

5. The assembly of claim 4 wherein each tension string is provided with an adjustment means to enable adjustment of the gap between the magnets.

6. The assembly of claim 1 wherein each tension string comprises a plurality of micro-fibres within the string.

7. The assembly of claim 1 wherein each tension string comprises a plurality of low stretch, high strength fibres.

8. The assembly of claim 1 wherein four tension strings are provided.

9. The assembly of claim 1, further comprising:
a third magnet fixed relative to the support platform and spaced from the first magnet;
a fourth magnet fixed relative to the chassis and spaced from the second magnet such that a magnetic attractive force occurs between the third and fourth magnets.

10. (canceled)

11. (canceled)

12. (canceled)

13. A turntable comprising:
a support platform comprising a tonearm mounting board configured to allow a tonearm to be fixed thereto;
a chassis; and
an assembly as defined in claim 1 for isolating the tonearm from the chassis.

14. The turntable of claim 13, further comprising a second assembly as defined in claim 1, wherein the second assembly is spaced from the first assembly and the tonearm mounting board is secured to both assemblies.

15. (canceled)

16. An assembly for isolating a component from vibrations present in a chassis, the assembly comprising:
a mounting pod for carrying the component;
a first upper magnet fixed to a lower surface of the mounting pod;
a second lower magnet fixed relative to a lower part of the chassis, the upper and lower magnets being positioned such that a magnetic attractive force occurs there between; and
a plurality of tension strings suspending the mounting pod from an upper part of the chassis such that a gap is maintained between the upper and lower magnets.

17. The assembly of claim 16 wherein each tension string is provided with an adjustment means to enable adjustment of the gap between the magnets.

18. The assembly of claim 16 wherein each tension string comprises a plurality of micro-fibres within the string.

19. The assembly of claim 16 wherein each tension string comprises a plurality of low stretch, high strength fibres.

20. The assembly of claim 16 wherein four tension strings are provided.

21. The assembly of claim 16, further comprising:
a third upper magnet fixed to a lower surface of the mounting pod and spaced from the first upper magnet;
a fourth lower magnet fixed relative to the lower part of the chassis and spaced from the second lower magnet such that a magnetic attractive force occurs between the third and fourth magnets.

22. An assembly for isolating a component from vibrations present in a chassis, the assembly comprising:
a support platform configured to carry the component;
a first magnet fixed relative to the support platform;
a second magnet fixed relative to the chassis, the first and second magnets being positioned and orientated such that a magnetic attractive force occurs there between; and
a spacing means, comprising a compliant material sandwiched between the magnets, to prevent the magnets coming into contact with each other but allow relative movement between the magnets in a direction lateral to the magnetic attractive force.

23. (canceled)

24. (canceled)

25. The assembly of claim 22 wherein the compliant material comprises a mass loaded elastomer.

26. A turntable including comprising:
a support platform comprising a tonearm mounting board configured to allow a tonearm to be fixed thereto;
a chassis; and
an assembly as defined in claim 22 for isolating the tonearm from the chassis.

27-33. (canceled)
